(19) United States
(12) Patent Application Publication
(10) Pub. No.: US 2018/0080598 A1
(43) Pub. Date: Mar. 22, 2018

(54) COUNTERBALANCED DISPLAY STAND

(71) Applicant: Apple Inc., Cupertino, CA (US)

(72) Inventors: Christiaan A. LIGTENBERG, San Carlos, CA (US); Bradley J. HAMEL, Redwood City, CA (US); Brett W. DEGNER, Menlo Park, CA (US); Scott J. KRAHN, Los Gatos, CA (US); Kristopher P. LAURENT, Campbell, CA (US); Robert J. LOCKWOOD, San Carlos, CA (US)

(21) Appl. No.: 15/447,052

(22) Filed: Mar. 1, 2017

Related U.S. Application Data
(60) Provisional application No. 62/397,304, filed on Sep. 20, 2016.

(51) Int. Cl. F16M 11/18; F16M 11/24; F16M 11/04; F16M 11/12; G06K 9/00; H04N 5/232

(52) U.S. Cl. CPC F16M 11/18; F16M 11/24; F16M 11/046; F16M 11/041; F16M 11/12; F16M 2200/063; H04N 5/23293; F16M 2200/061; F16M 2200/066; F16M 2200/047; F16M 2200/08; G06K 9/00335

(57) ABSTRACT

A counterbalanced display stand can be used with a tablet or other suitable portable electronic device. The display stand can allow for tilt, rotation, and lateral movement in multiple directions to arrive at a desired display position. A 4-bar linkage arrangement can allow for such movements, which can be manual from a user and/or motorized through other device components. The display stand can be counterbalanced such that minimal friction is required to hold the device at a desired display position. A magnetic connector can detachably connect the device to the display stand. A feedback component can facilitate an automated repositioning of the display stand in response to changing conditions.

### CROSS-REFERENCE TO RELATED APPLICATION

This application claims the benefit of priority under 35 U.S.C. § 119(e) to U.S. Provisional Application No. 62/397,304, entitled “COUNTERBALANCED DISPLAY STAND,” filed Sep. 20, 2016, which is incorporated by reference herein in its entirety.

### FIELD

The described embodiments relate generally to portable electronic device accessories. More particularly, the described embodiments relate to display stands that are used in conjunction with portable electronic devices.

### BACKGROUND

Many modern portable electronic devices have visual display screens that can convey and wide variety of pictures, video, and other information. There can be instances where presentations to many people are made using the display screen of a portable electronic device, in which case the presentation of the display screen to all people simultaneously can be difficult or awkward. Further, there can also be instances where the presentation of the display screen to a single user can be cumbersome, such as where a user must typically hold or carry the device while doing other activities as well. Such display screens often function as input devices as well, such as in the case of touch screens. Where a user desires to provide touch input to the display screen, the presentation of the display screen might also require a single user to hold the device physically, which may be inconvenient given the circumstances. While portable electronic devices having visual display components have thus worked well in the past, there can be room for improvement. Accordingly, there is a need for electronic device accessories having improved display presentation capabilities.

### SUMMARY

Representative embodiments set forth herein disclose various structures, methods, and features for the disclosed portable electronic device accessories. In particular, the disclosed embodiments set forth stands suitable for use with portable electronic devices having visual displays. Such stands can be counterbalanced display stands in some cases.

According to various embodiments, a stand assembly configured for use with a portable electronic device having a display screen for presenting visual content includes at least a base, a mechanical assembly supported by and movably coupled to the base, the mechanical assembly having mechanical arms and linkages, a connector at a first end of the mechanical assembly, the connector configured to detachably connect the portable electronic device to the mechanical assembly. The mechanical assembly allows movement of the connector in multiple directions to arrive at different positions and provide different adjustable orientations of the display screen with respect to the base when the portable electronic device is connected to the connector. A weighted component is coupled to the mechanical assembly at a second end that is opposite the first end, and the weighted component is configured to counterbalance a weight of the portable electronic device and maintain a set orientation of the display screen selected from the different adjustable orientations of the display screen.

In some embodiments, a stand for supporting an electronic device having a display for presenting visual content includes at least a base, a device connector suitable for connecting to the electronic device, a track pole coupled to the device connector and supported by the base, the track pole including a track that allows movement of the device connector with respect to the base. When the electronic device is connected to the device connector, movement of the device connector along the track repositions the display with respect to the base. The stand also includes a spring assembly coupled to the device connector that biases the movement of the device connector along the track.

A method of presenting a display screen of an electronic device is carried out by detecting a condition by a feedback component, providing a signal regarding the detected condition from the feedback component to a controller, and automatically adjusting a mechanical assembly connected to the electronic device using the controller to adjust the tilt, rotation, and lateral position of the display screen.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described will become apparent from the following Detailed Description, Figures, and Claims.

### BRIEF DESCRIPTION OF THE DRAWINGS

The included drawings are for illustrative purposes and serve only to provide examples of possible structures and methods for the disclosed display stands. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1A illustrates in top plan view an exemplary portable electronic device according to various embodiments of the present disclosure.

FIG. 1B illustrates in front perspective view the portable electronic device of FIG. 1A according to various embodiments of the present disclosure.

FIG. 2 illustrates in side elevation view an exemplary display stand configured to present the display of the portable electronic device of FIGS. 1A-1B according to various embodiments of the present disclosure.

FIG. 3 illustrates in top perspective view a display stand having a portable electronic device attached thereto according to various embodiments of the present disclosure.

FIG. 4A illustrates in side view a display stand having a portable electronic device attached thereto in a landscape orientation and lowered elevation according to various embodiments of the present disclosure.

FIG. 4B illustrates in side view a display stand having a portable electronic device attached thereto in a portrait orientation and raised elevation according to various embodiments of the present disclosure.

FIG. 4C illustrates in side view a display stand having a portable electronic device attached thereto and raised in elevation with respect to a table according to various embodiments of the present invention.

FIG. 4D illustrates in side view a display stand having a portable electronic device attached thereto and lowered in elevation with respect to a table according to various embodiments of the present invention.

FIG. 5A illustrates in rear view a portable electronic device having an exemplary display stand connector configured for connecting to a display stand affixed thereto according to various embodiments of the present disclosure.

FIG. 5B illustrates in perspective view an exemplary device connector according to various embodiments of the present disclosure.

FIG. 5C illustrates in perspective view an exemplary display stand connector according to various embodiments of the present disclosure.

FIG. 6A illustrates in block diagram format an exemplary linear spring based display stand arrangement according to various embodiments of the present disclosure.

FIG. 6B illustrates in front view and in block diagram format the display stand arrangement of FIG. 6A including a track according to various embodiments of the present disclosure.

FIG. 7 illustrates in block diagram format an exemplary scissor based display stand arrangement according to various embodiments of the present disclosure.

FIG. 8A illustrates in side view a display stand having a portable electronic device attached thereto and lowered in elevation with respect to a table attached to an external input device according to various embodiments of the present invention.

FIG. 8B illustrates in side view a display stand having a portable electronic device attached thereto, raised in elevation with respect to a table and detached from an external input device according to various embodiments of the present invention.

FIG. 9 illustrates a flowchart of an exemplary method of presenting a display screen of an electronic device according to various embodiments of the present disclosure.

FIG. 10 illustrates in block diagram format an exemplary portable electronic device that can be used to implement the various components and techniques described herein according to various embodiments of the present disclosure.

### DETAILED DESCRIPTION

Display stands can be used in conjunction with electronic devices to provide for improved ways of presenting device display content in a simpler and more aesthetically pleasing way. According to various embodiments, a counterbalanced display stand can facilitate the presentation of a visual display on a separate associated portable electronic device. The counterbalanced display stand can include a connector configured to detachably connect the separate device, mechanical arms and linkages coupled to the connector to allow a wide range of movement and rotation for the separate device, and a weighted component to counterbalance the weight of the separate device. In addition, a feedback component can facilitate an automated repositioning of the display stand.

In some embodiments, the counterbalanced display stand can be used with a tablet or other suitable portable electronic device. The display stand can allow for tilt, rotation, and lateral movement in multiple directions to arrive at a desired display position. A 4-bar linkage arrangement can allow for such movements, which can be manual from a user and/or motorized through other device components. The display stand can be counterbalanced such that minimal friction is required to hold the device at a desired display position. The connector can be magnetic to detachably connect the device to the display stand. The feedback component can facilitate an automated repositioning of the display stand in response to changing conditions.

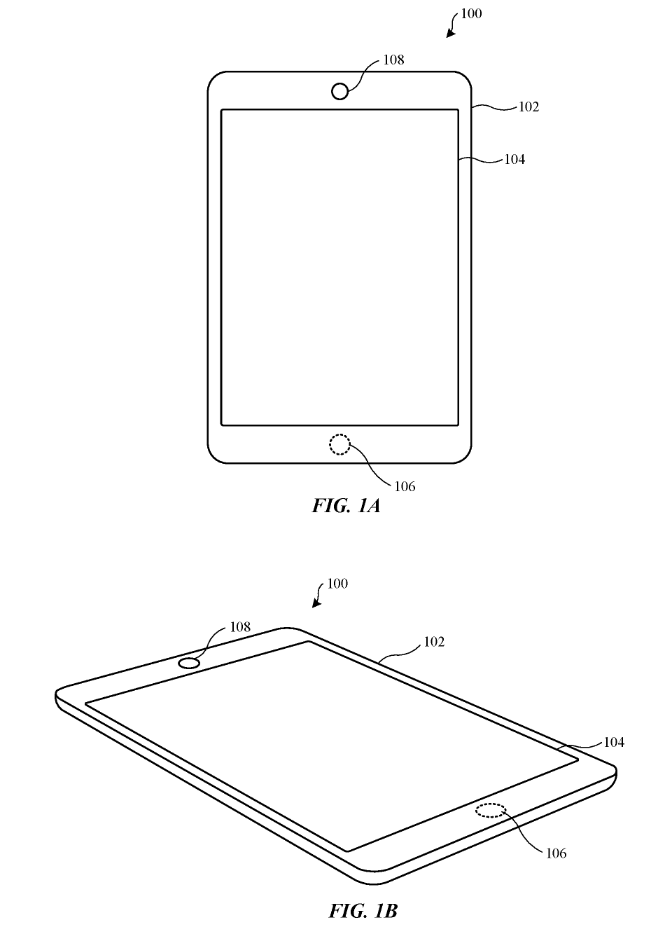

The foregoing approaches provide various structures and methods for the disclosed counterbalanced display stands. A more detailed discussion of these structures, methods, and features thereof is set forth below and described in conjunction with FIGS. 1A-10, which illustrate detailed diagrams of devices and components that can be used to implement these structures, methods, and features.

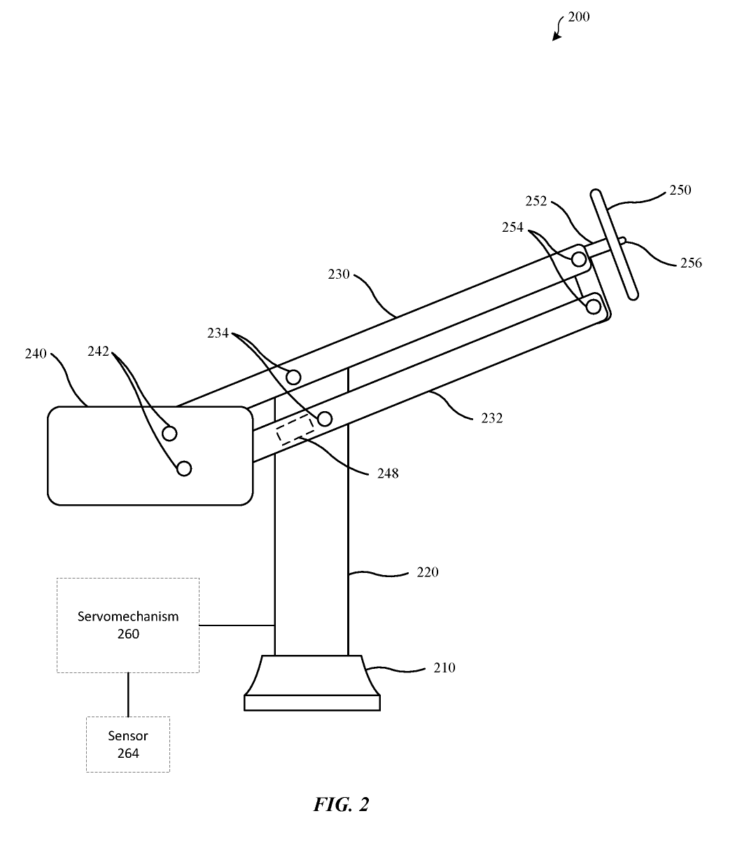

Turning first to FIGS. 1A and 1B, an exemplary portable electronic device is illustrated in top plan and front perspective views. Portable electronic device 100 can be a tablet computing device, for example, although other similar types and varieties of electronic devices can also apply for the various disclosed components and features disclosed herein. For example, the various counterbalanced display stands disclosed herein could also be used with a smart phone, a media playback device, a personal digital assistant, and a laptop computer, among other possible portable electronic devices. Portable electronic device 100 can include an outer housing 102, which can be adapted to hold a processor and other electronic components inside, and can also provide space for an exterior touchscreen or other display 104, one or more buttons, such as home button 106 and a camera 108, among other possible device components. The home button 106 may be virtual and may be optionally included with the electronic device 100. In embodiments where the device 100 is provided with a touch display, the display 104 may have touch capabilities well suited for receiving a touch event (and/or, in embodiments where the device 100 includes a haptic device, providing haptic feedback as a touch even), that can be used, for example, to control various operation of the electronic device as well as the display stand (FIG. 2) if appropriately configured.

Turning next to FIG. 2, an exemplary display stand configured to present the display of the portable electronic device of FIGS. 1A-1B is illustrated in front perspective view. While display stand 200 is configured to support and present portable electronic device 100 above, it will be appreciated that display stands having similar components can be suitably dimensioned to support and present other portable electronic devices having different sizes, shapes, and weights. Display stand 200 can include a base 210 and a central shaft 220 extending upward therefrom. Mechanical arms 230, 232 can be arranged in parallel to each other and be pivotally coupled to the central shaft 220 by way of central shaft linkages 234. A weighted component 240 can be coupled to mechanical arms 230, 232 on one side of central shaft 220 by way of weighted component linkages 242. A device connector 250 can be coupled to mechanical arms 230, 232 on the other side of central shaft 220 by way of a connector coupling 252 and connector coupling linkages 254. As shown in FIG. 2, the display stand 200 is not supporting and presenting any separate portable electronic device, and yet can still alone with no such separate device.

The base 210 and central shaft 220 can function to provide a foundation and support for the entire display stand 200 and a separate supported portable electronic device, if present. In some embodiments, the central shaft 220 can be arranged to rotate about a longitudinal rotation axis extending there through with respect to the base 210 while the base 210 remains stationary, such that the entire display stand 200 except for the base all rotates together. A full or limited range of rotation can be possible, such that the device connector 250 (and rest of the display stand) can be rotated about the central shaft 220 and base 210. Accordingly, multiple different possible rotational display positions for a display on the separate portable electronic device can be achieved by rotating the device, mechanical arms 230, 232, various linkages 234, 242, 254, and other display stand components about the central shaft 220 and base 210. A brake, clutch, or other locking component can be used to hold the rotation position of the central shaft 220 and/or rotation of other components, if desired. In some embodiments, rotation of the central shaft 220 may not be available.

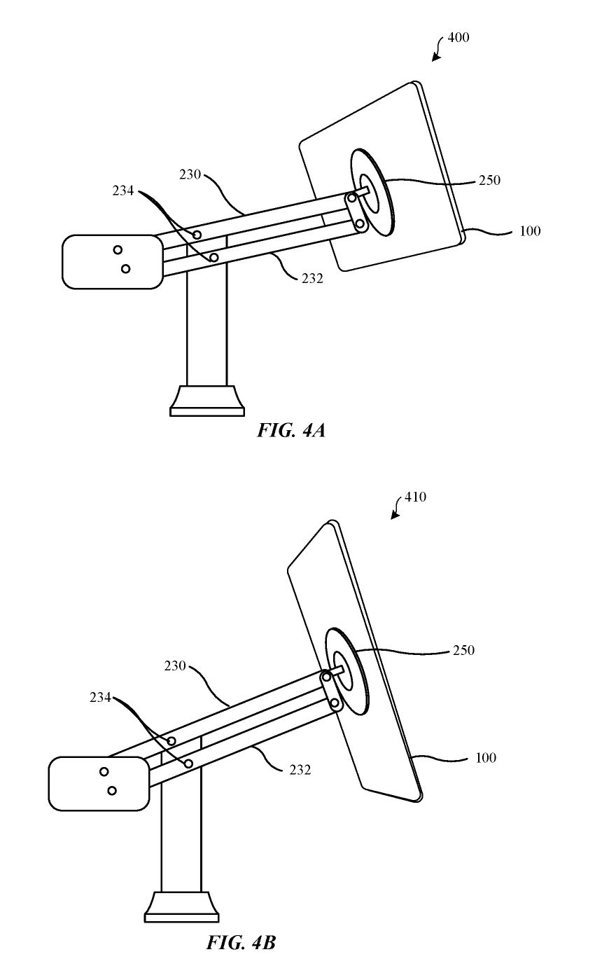

The mechanical arms 230, 232, weighted component 240, device connector 250, and various linkages 234, 242, 254 can all function together to form a 4-bar linkage that permits the coordinated rotational movement of the mechanical arms 230, 232, such that the device connector 250 can be raised and lowered laterally to multiple different elevated positions relative to the surface on which the base 210 rests. The central shaft linkages 234, weighted component linkages 242, and connector coupling linkages 254 can each include two linkages that allow the two respective components being linked to rotate or pivot about each other, as in the case of a typical 4-bar linkage. Each of the various linkages 234, 242, 254 can include a pin, shaft, or other suitable component that provides a coupling axis about which the coupled components can rotate or pivot. Overall then, mechanical arms 230, 232 and linkages 234, 242, 254 are all coupled to the device connector 250 and are configured to allow relative movement of the device connector in multiple lateral and rotational directions to arrive at each of a wide number of multiple different possible presentation positions for a display of the separate portable electronic device, when attached. The display stand 200 may also be supported by a support surface (such as the table surface shown in FIGS. 4C, 4D, etc.). The support surface may be horizontal, vertical, and/or other suitable orientations. In some embodiments, the display stand 200 is attached to the support surface at the base 210 such that the base 210 may be secured to the support surface via a securing mechanism (e.g., fasteners).

The weighted component 240 can be of a size, shape, material, and distance from central shaft linkages 234 such that the weighted component 240 and weighted component linkages 242 provide an exact or very close counterbalance for the combined weight and distance of a separate portable electronic device (not shown), device connector 250, connector coupling 252, and connector coupling linkages 254. Accordingly, when the separate portable electronic device (such as a tablet device) is not attached, as shown in FIG. 2, then the weighted component 240 causes the mechanical arms 232, 234 to rotate to a full position where the weighted component 240 is as low as possible and the device connector 250 is as high as possible. When the separate portable electronic device is attached, however, then the moment on both sides of central shaft linkages 234 is equal or nearly equal, such that the weight of the weighted component 240 times its distance from the central shaft linkages is the same as the weight of the separate portable electronic device and its coupling components times their distance from the central shaft linkages.

As such, the weighted component 240 counterbalances the weight of the separate portable electronic device when the device is attached, such that the weighted component and separate portable electronic device will remain in whatever position they are placed. It can then take a minimal force to move the separate device up and down when it is attached to the display stand 200. In various embodiments, the amount of friction in the various linkages 234, 242, 254 can be minimized in order to allow for such minimal force to move the separate portable electronic device from one elevated position to another while it is attached. In fact, the amount of friction in the linkages 234, 242, 254, can be just sufficient to hold the separate portable electronic device in a particular position or relative elevation until a minimal or small amount of force is applied to move it to a different position or relative elevation. In some embodiments, one or more brakes, clutches, or other stops 248 can be optionally applied to one or more of the various linkages 234, 242, 254, such that a given position or relative elevation of the attached separate portable electronic device can be strongly held, if desired. A positive input or actuation can be available to release such a brake, clutch, or other stop, if used.

Device connector 250 can be coupled to mechanical arms 230, 232 at or near the ends of the arms that are on the opposite side of central shaft linkages 234 from weighted component 240. A connector coupling 252 can be used to couple the device connector 250 to the mechanical arms 230, 232 in a manner that fashions a 4-bar linkage, and the separate connector coupling can rotate or pivot with respect to the arms such that a display or presentation angle of a display on the separate portable electronic device can be adjusted when the device is attached. In some embodiments, the mechanical arms 230, 232, various linkages 234, 242, 254 and/or other components of display stand 200 can be configured such that the presentation angle of the separate device display remains constant when the separate device is raised or lowered. In other embodiments, the various components can be configured such that the presentation angle is adjusted when the separate device is raised or lowered. For example, the presentation angle can be adjusted relative to the location of a user at some distance away from the display screen.

The device connector 250 can also be configured to detachably connect the separate portable electronic device to the display stand 200 such that a display screen on the portable electronic device is presentable to a user from multiple different possible display positions. Several ways of achieving a readily attachable and detachable connection from the separate device to the device connector 250 are set forth in greater detail below, some of which can involve one or more further system components that can be coupled or attached to the separate device in order to facilitate such attachments. For example, a pin 256 can be used to facilitate a readily attachable and detachable connection with the separate device. In some embodiments, the device connector 250 can be round and relatively flat, like a disc type shape, and is smaller than the separate device to which it attaches. This can allow the device connector to have a separate ability to rotate on its central axis, such as with respect to connector coupling 252. The attached tablet or other separate portable electronic device can then be rotated about a central axis through its own display with respect to the remainder of the display stand 200 as well.

The display stand 200 may optionally also include a servomechanism 260 and a sensor 264. The servomechanism 260 may be configured to operate mechanical components of the display stand 200, such as the central shaft 220, mechanical arms 230, 232, linkages 234, 242, 254, and/or device connector 250, to facilitate mechanical movement of the display stand 200 and adjust the position of an electronic device (not shown) attached to the device connector 250. The sensor 264 may include a camera, a motion sensor, etc., configured as a feedback component that detects position information (e.g., positioning data regarding the position of a user of the device attached to the display stand 200) and sends the data to a processor such that the display stand 200 automatically adjusts the position of the device via servomechanism 260 in response to the detected position, as is described in further detail below. The sensor 264 may be coupled to the servomechanism 260 and/or attached to a portion or portions of the display stand 200. The sensor 264 may also include an array of multiple sensors positioned with respect to the display stand 200. Further, the sensor 264 may be configured to detect a position of the display stand 200, device 100, or both and provide the detected data to the servomechanism 260.

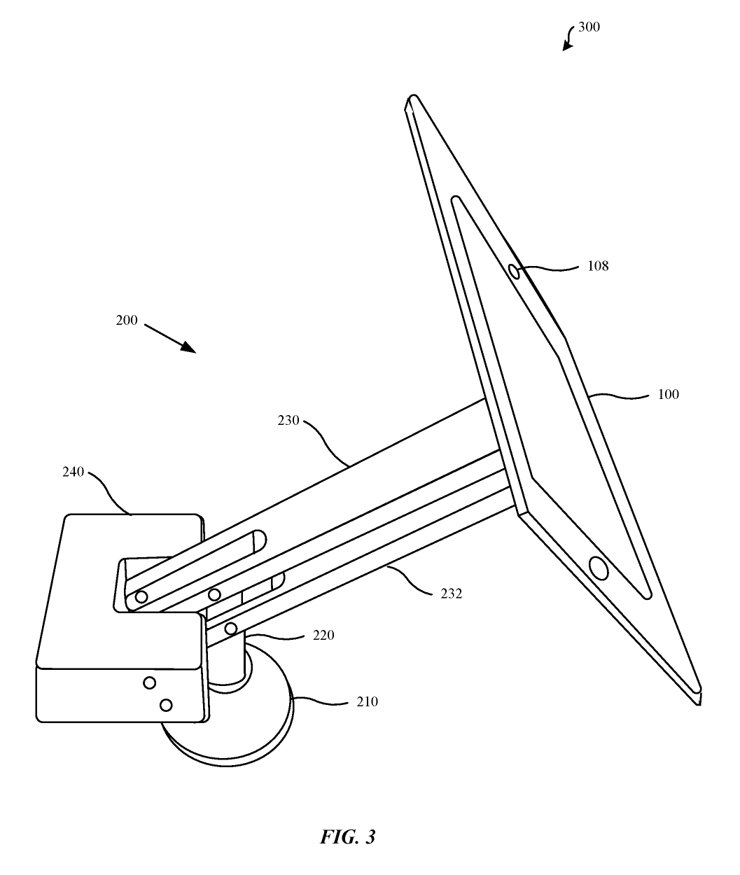

Continuing with FIG. 3, the display stand 200 of FIG. 2 is shown in top perspective view having a portable electronic device 100 attached thereto according to various embodiments of the present disclosure. Configuration 300 depicts the foregoing display stand 200 with a separate portable electronic device 100 attached thereto. Portable electronic device 100 can include a camera 108, and may include other input or feedback components that may be used in conjunction with the display stand 200, as discussed in greater detail below. As shown, the portable electronic device 100 is oriented in landscape mode, is elevated to a relatively high location (e.g., at a height near a highest elevation the display stand can achieve), and is set at a relatively high level of tilt for a presentation angle than can be significantly above the surface upon which base 210 rests. It will be understood that in various embodiments, one or more of these settings can be readily adjusted as desired by a given user. For example, the orientation of the electronic device can be rotated from the landscape to a portrait mode, the elevation above the support surface can be reduced or increased even higher, and the amount of tilt can be increased or decreased. Furthermore, the rotational position of central shaft 220 can be altered such that the portable electronic device 100 is capable of facing different directions. In this way, visual content presented by the display 100 can be viewed in any direction as well as providing access to the surface (e.g., a touch surface).

FIGS. 4A and 4B illustrate in side elevation view the display stand of FIG. 2 having a portable electronic device attached thereto. FIG. 4A shows the device in a landscape orientation and lowered elevation, while FIG. 4B shows the device in a portrait orientation and raised elevation. In configuration 400 of FIG. 4A, the portable electronic device 100 (i.e., tablet) is attached to the display stand 200, and is turned sideways in a landscape orientation at a reduced elevation with respect to the support surface (i.e., table) on which the display stand rests. As shown, the back of device connector 250 is visible, and it can be seen that the device connector is attached to the portable electronic device 100. This can be a direct attachment to the portable electronic device 100, or can be an attachment to another component that forms part of a display system. Such another component can then be affixed to the portable electronic device 100, as noted below.

In various embodiments of the disclosed display stand 200, rotational movement of the portable electronic device 100 can be controlled by rotating the portable electronic device 100 with respect to at least the plurality of mechanical arms 230, 232 and various linkages. In configuration 410 of FIG. 4B, the portable electronic device 100 has been rotated about 90 degrees to from the landscape to the portrait orientation simply by rotating the portable electronic device 100 with respect to the device connector 250. This can be facilitated by the type of connection between the portable electronic device 100 and the device connector 250. For example, device connector 250 can include a magnetic connector that provide a magnetic attachment that allows for relative rotation between the device connector 250 and the electronic device 100. The portable electronic device 100 has also be raised to a higher elevation than in that shown in configuration 400 by way of rotating the mechanical arms 230, 232 either counterclockwise or clockwise with respect to central shaft linkages 234. Alternatively, the portable electronic device 100 and the connector coupling 252 can be rotated together with respect to at least the mechanical arms 230, 232 and various linkages, such as where a rotational bearing in the connector coupling might be used.

The portable device 100 being in raised and lowered elevations is shown in FIGS. 4C and 4D. In configuration 420, the portable device 100 is raised in elevation with respect to a support surface In the embodiment shown in configuration 420, the portable device 100 is attached to the display stand via the device connector 450. The device connector 450 may include a positioning pin 452 for positioning and receiving a display stand connector 454 (e.g., via a positioning recess in the display stand connector 454) that is attached to the portable device 100. The connection between the device connector 450 and the display stand connector 454 may be magnetic, such that the device connector 450 is capable of forming a magnetic connection with display stand connector 454. In some embodiments, the device 100 may include a magnetic element configured for attachment of the device 100 to the display stand.

At FIG. 4D, the portable device 100 is shown at a lowered elevation with respect to the support surface in configuration 430. In both configurations 420 and 430, the weighted component 240 may act as a counterbalance weight such that the portable device 100 is prevented from movement absent application of an external force. As shown, the linkage 254 may be adapted to rotate or adjust such that, when the elevation of the device 100 is lowered, the presentation angle of the display 100 (e.g., the angle of orientation of the device connector 450 and display stand connector 454) remains generally similar between a raised elevation and a lowered elevation with respect to the support surface.

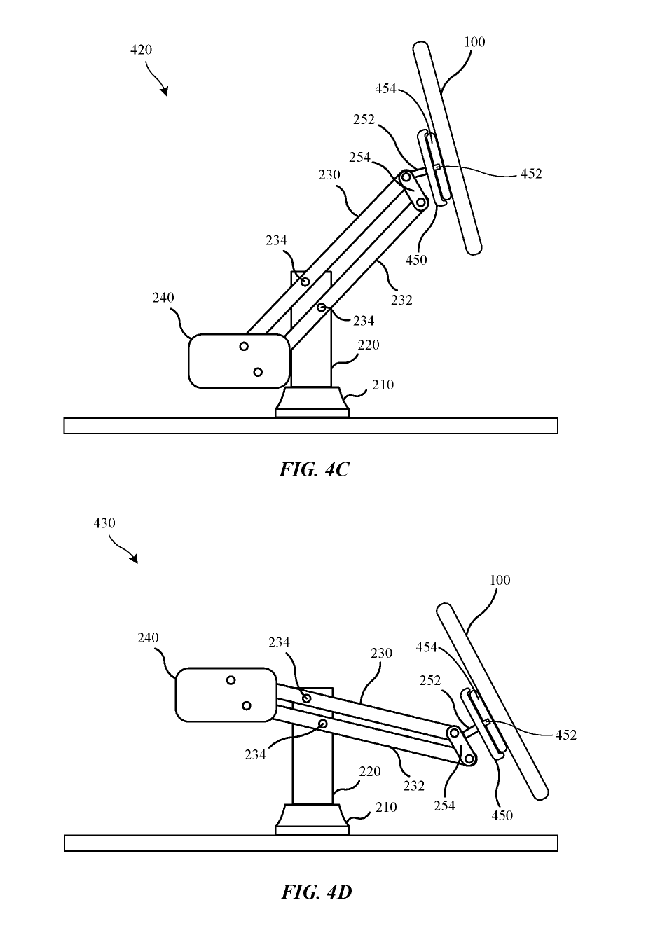

In various embodiments, an additional component forming part of an overall display system can be used in conjunction with a display stand, such that a given portable electronic device can be readily attached and detached from the display stand. Such an additional component can be affixed to or alternatively embedded within the portable electronic device, and can be configured to facilitate a readily detachable connection to the display stand. FIG. 5A illustrates in rear view a portable electronic device having an exemplary display stand connector configured for connecting to a display stand affixed thereto according to various embodiments of the present disclosure. In various arrangements, portable electronic device 100 may or may not come with such a display stand connector affixed thereto or embedded therein. As shown in configuration 500, display stand connector 550 can be an accessory that is external to and affixed to the back housing of an existing portable electronic device 100. Display stand connector 550 can be disc shaped, and can have a central hole 552 and a first set of one or more magnets 554 to facilitate a readily detachable connection with a mating device connector.

FIG. 5B illustrates in perspective view an exemplary device connector configured for connecting to the display stand connector of FIG. 5A according to various embodiments of the present disclosure. As noted above, device connector 510 is configured to be used with a display stand 200 such that the display stand 200 can connect to a portable electronic device. FIG. 5C illustrates in perspective view the exemplary display stand connector of FIG. 5A. Again, display stand connector 550 is configured to be used with a portable electronic device 100 such that the portable electronic device can connect to a display stand, such as to a suitable device connector on the display stand.

To facilitate mating with a suitable display stand connector 550 as shown, device connector 510 can also be disc shaped, and can have a central pin 556 of a size and shape to mate with the central hole 552 of the display stand connector 550. In addition, device connector 510 can have a second set of one or more magnets 558 that are configured to attract and facilitate an attachment or coupling with the first set of one or more magnets 554 of the display stand connector 550. Each set of magnets 558, 554 can be arranged in a pattern that can include alternating polarities and different strengths as may be desired to facilitate an appropriate and aligned readily detachable connection between the display stand connector 500 and the device connector 558. The strength of the magnetic attraction between the first set of one or more magnets 554 and the second set of one or more magnets 558 can be sufficient to hold the display stand connector 550 and affixed portable electronic device to the device. Although the central hole 552 is shown formed in the display connector 550 and the pin 556 is shown formed in the device connector 510, an opposite configuration may be utilized as desired.

The device connector 510 may also include positioning protrusions 562 arrange by particular configuration to mate with divots 564 formed in the display stand connector 550. As shown the protrusions 562 and divots 564 are positioned at 90 degree intervals, although alternative intervals may be used. The positioning of a protrusion 562 into a divot 564 may be utilized as stop locations, for example, when a user is rotating the portable device 100 while the portable device 100 is attached to the display stand 200. The device connector 510 and the display stand connector 550 may optionally include a latch 570 which may mechanically or electronically disconnect the portable device 100 from the display stand 200 when activated (e.g., pushing a pin against one of the connectors, disengaging the magnetic connection when the magnetic connection is electrically based, etc.). The latch 570 may also, for example, be integrated in the connector(s) 510, 550 and activated by a trigger option presented to the user via the portable device 100.

Other embodiments can involve other forms of detachable connections between a display stand and portable electronic device. For example, the magnetic component at the portable electronic device may be fully or partially embedded within the device or the housing of the device. In other arrangements, multiple pins and holes can be used. Further, various alternative ways of connecting a portable electronic device to a display stand can be used, such as tabs, buckles, clamps, hooks, and the like.

In various embodiments, a feedback component (e.g., the sensor 264 of FIG. 2) can be utilized to help with adjusting or readjusting the positioning of the portable electronic device and the presentation angle of its display. Such a feedback component can be, for example, camera 108 on the exemplary portable computing device 100 above. While many embodiments can include the ability to manually adjust these various features, an automated adjusting can also or alternatively be used (e.g., via servomechanism 260 of FIG. 2). This can involve the lateral rotational position of the device, the lateral vertical position of the device, the tilt of the device to affect the presentation angle, and the rotation of the device to affect the presentation mode (portrait, landscape, or other). Where automated, one or more servo-motors or other suitable electromechanical components (e.g., servomechanism 260) can be used to receive signals from an associated processor and adjust the various components that affect presentation, such as central shaft rotation, mechanical arm movement, and/or device connector rotation, as may be appropriate.

In some embodiments, the feedback component can be a sensor or a camera, which can be configured to detect display presentation conditions, users, and/or other items in the environment of the display stand and portable electronic device. The camera can be a separate item that is included on the display stand itself, or can be separate from the display stand. In some arrangements, the camera can be one that is embedded on the portable electronic device, such as camera 108 on the exemplary portable computing device 100 above. Multiple cameras can also be used in some arrangements. In further embodiments, the feedback component can simply be a manual input that a user can provide to a controller. Such input can be made on the portable electronic device itself, or can be by way of another device or remote control, for example. The feedback component can also be a speaker, which can involve voice recognition for verbal commands. Other forms of feedback may also be used.

In various embodiments, the display stand can be configured to have a portable electronic device such as a tablet device connected to the display stand use its own camera to detect conditions during presentation of the display on the portable electronic device. The camera and processor on the portable electronic device can then be adapted to send signals to motors and/or other components on the display stand to facilitate an automated adjustment or readjustment of the tilt, rotation, and/or lateral positions of the portable electronic device during display presentation. Accordingly, the device connector and display stand connector can be further adapted to include mating interfaces to facilitate the communication of signals between the portable electronic device to the automated display stand components while the portable electronic device is attached. Alternatively, or in addition, a wireless transmission between the portable electronic device and the automated display stand components can be configured and used.

Various display presentation conditions can affect such automated adjusting or readjusting of the positioning, tilt, and orientation of the portable electronic device. Such conditions can include an increase or decrease in lighting, sound, or parts of the presentation being displayed. In some arrangements, detection of user movement can be used. For example, the location of a primary user or viewer can be tracked, and the display screen presentation can be adjusted accordingly to follow the user as he or she moves about a room or otherwise changes location with respect to the portable electronic device. As another example, the elevation and tilt angle of the display screen can be readjusted in response to a user slouching or sitting up in his or her chair. A panning presentation effect can be provided where a given display is to be shown to many users that are not all one location as well. Other forms of feedback and automated readjusting of the display presentation are also possible.

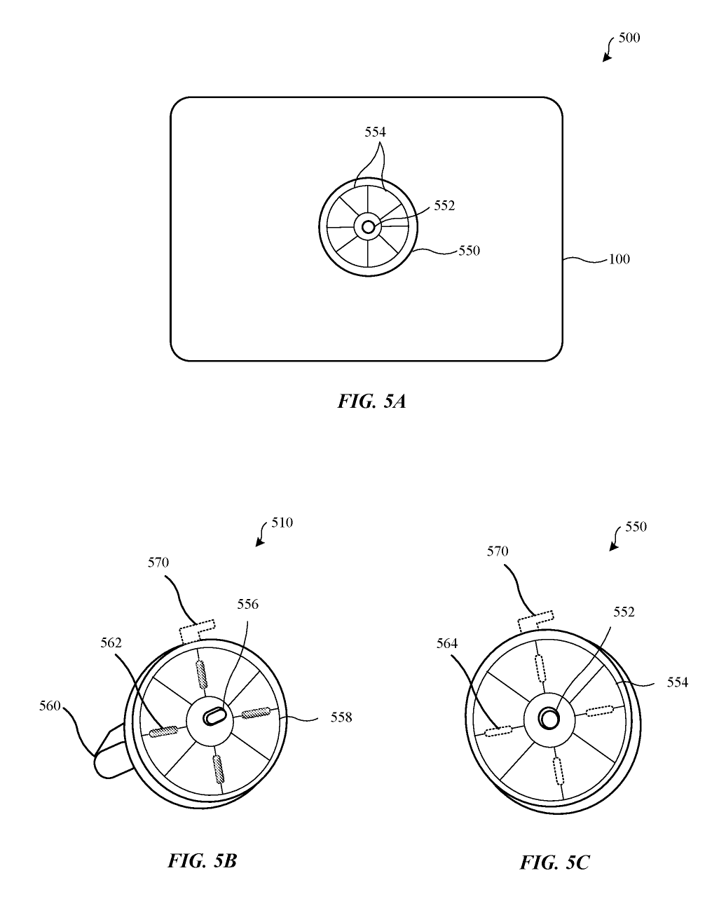

While the foregoing embodiments and examples all involve a counterbalanced design to a display stand, other forms of mechanical display stands that allow convenient manual positioning and even automated positioning for an attached electronic device can alternatively be used. Moving now to FIGS. 6A and 6B, an exemplary linear spring based display stand arrangement is shown in block diagram format. Arrangement 600 involves a portable electronic device 100 that can be coupled by way of a device connector 660 to a track pole 662. The portable electronic device 100 and device connector 660 can slide together up and down (e.g., from position A to position B in configuration 610 of FIG. 6B) a track 672 associated with track pole 662, such that the lateral elevation of the portable electronic device 100 can be adjusted accordingly. A spring 668 can bias the up and down movement along track pole 662, and the spring 668 be coupled to a cam 664 by way of a cable or other spring connector 666. The cam arrangement can be used to alter the amount of force observed as the device and device connector move up and down, such that the amount of force seems to be the same even as the spring extends or compresses, and the up and down movement is thereby smooth for a user.

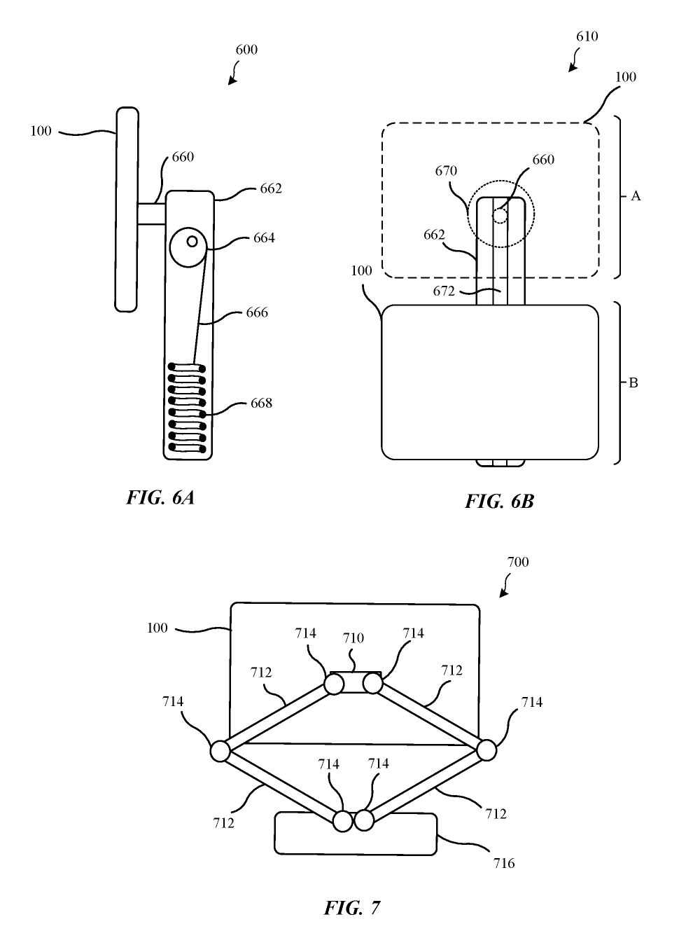

As another example of an alternative arrangement, FIG. 7 illustrates in block diagram format an exemplary scissor based display stand arrangement according to various embodiments of the present disclosure. Arrangement 700 involves a portable electronic device 100 that can be coupled by way of a device connector 710 to multiple scissor arms 712. Various counterbalanced spring connectors 714 can be coupled to the device connector 710, the multiple scissor arms 712, and a base 716 upon which the display stand rests. The scissor arms 712 and counterbalanced spring connectors 714 can be arranged such that each side acts in parallel and the sides are coordinated to facilitate an up and down movement of the overall display stand. Other mechanical display stand design types can also be used, as may be desired.

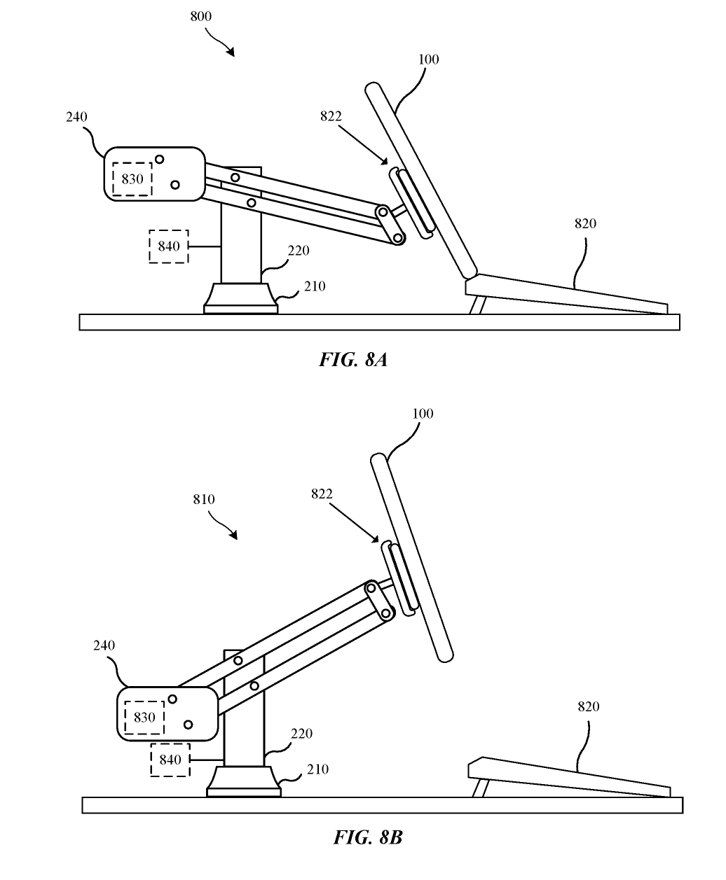

FIGS. 8A and 8B show configurations including a display stand and a portable electronic device with an external attachable input mechanism. In configuration 800, the device 100 is attached to the display stand via connector 822 and is in a lower elevation position. In configuration 810, the device 100 is in a higher elevation position. In the lower elevation position 800, the portable device 100 is positioned for attachment to an external input mechanism 820 (e.g., a keyboard, etc.) resting on the support surface. In the higher elevation position, the device 100 is in position above the input mechanism 820 and is detached from the mechanism 820. In some embodiments, the device 100 may maintain communication with the input mechanism 820 (e.g., wirelessly) such that, when the device 100 is detached from the input mechanism 820, a user of the device 100 may input information to the device 100 via input mechanism 820 while the device 100 is elevated away from the mechanism 820.

In some embodiments, as shown in FIGS. 8A and 8B, the display stand may optionally include a computing device 830 within the weighted component 240. The computing device 830 may be a computing system (including a processor, memory, etc.) configured to function with the device 100 and/or input mechanism 820 either wirelessly, and/or through connection of the device 100 (and the mechanism 820) to the display stand by way of the connector 822 (e.g., via wired connection through the display stand). Additionally, the display stand may also be connected to a power source 840 adapted to provide power to the computing device 830, or other components. For example, the power source 840 may provide power to a charging mechanism to charge a battery of the portable device 100 (e.g., wired connection, magnetic or inductive charging, etc.).

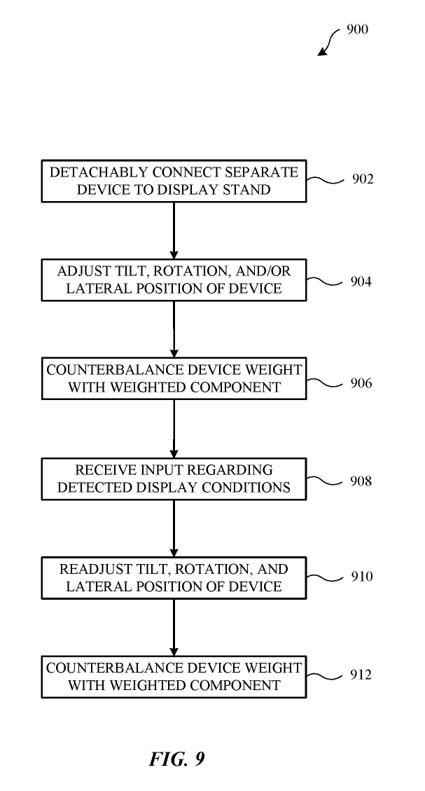

FIG. 9 illustrates a flowchart of an exemplary method of presenting a display screen of an electronic device according to various embodiments of the present disclosure. Method 900 can include process steps that can be performed entirely by a processor in or associated with a suitable electronic device, such as a portable electronic device being used for the display itself. For example, a tablet device being used to present its display screen can include the processor that performs various process steps herein. At a first process step 902, an electronic device is detachably connected to a display stand such that the display screen is visible to a user from multiple different possible display positions. Again, this can involve a magnetic connection between a first magnetic connector at the display stand and a second magnetic connector at the electronic device. Other features that facilitate a detachable connection can also be included, as noted in greater detail above.

At a following optional process step 904, one or more of the tilt, rotation, and lateral position of the display screen can be adjusted using a plurality of mechanical arms and linkages on the display stand. This can be automated, such as by way of a processor and one or more motors that operate to perform any desired movements to the various display stand components. At the next step 906, the device weight is counterbalanced with a weighted component that is coupled to the plurality of mechanical arms and linkages of the display stand. This can result in a minimal amount of friction being needed in the linkages to maintain any given tilt, rotation, and lateral position, such as those that have been adjusted. The weighted component can be used such as that which has been described in greater detail above.

At the next process step 908, an input can be received regarding one or more detected conditions in the presentation of the display screen. Such conditions can be changed or changing conditions, and can involve, for example, changing the location of a given user or viewer relative to the separate portable electronic device. The input can be received by way of a feedback component, such as a camera, speaker, or manual input feature, for example. Other types of feedback components are also possible. Changing conditions might also include a desire to present the display screen to other users or viewers, among other possibilities. At a following process step 910, one or more of the tilt, rotation, and lateral position of the display screen can be adjusted (or readjusted if applicable), again using the plurality of mechanical arms and linkages on the display stand. This can be automated and in response to the input at step 908, and can again be by way of a processor and one or more motors that operate to perform the desired movements. For example, the feedback component can detect a condition and in response provide a signal to the processor, which in turn may control the mechanical assembly by way of motor(s) and/or other automated features. At process step 912, the weight of the electronic device can be again counterbalanced using a weighted component on the display stand as described above.

For the foregoing flowchart, it will be readily appreciated that not every step provided is always necessary, and that further steps not set forth herein may also be included. For example, added steps that involve setting a brake clutch, or other stop for a given position may be added. Another step involving removing the separate device can also be included. Also, steps that provide detail with respect to how different types of input are processed can be added as well. Furthermore, the exact order of steps may be altered as desired, and some steps may be performed simultaneously. For example, step 904 may not be necessary, and step 912 may be performed at any time or all times after step 902. Simultaneous performance of all steps may also be possible in some instances.

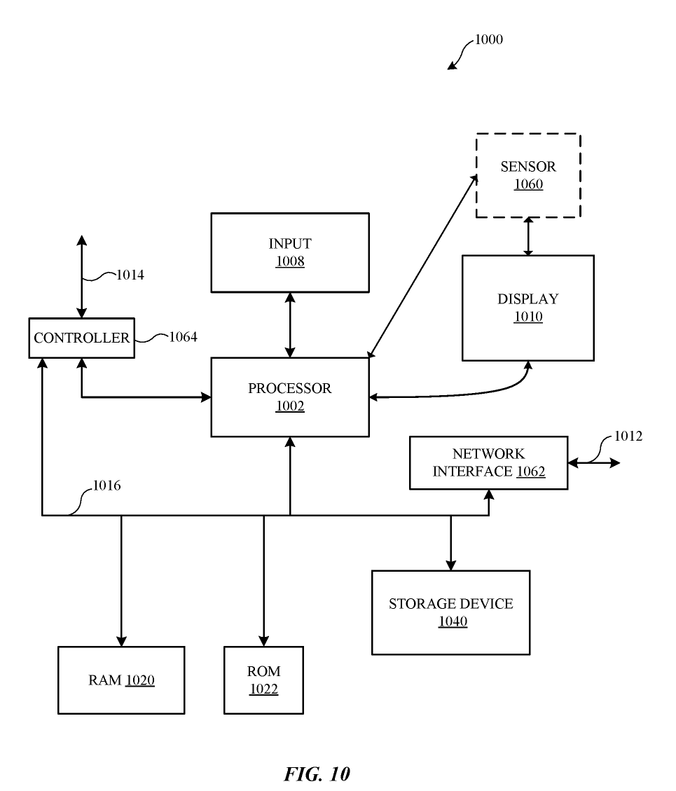

FIG. 10 illustrates in block diagram format an exemplary computing device 1000 that can be used to implement the various components and techniques described herein, according to some embodiments. In particular, the detailed view illustrates various components that can be included in the portable electronic device illustrated in the figures throughout. Again, other types of electronic devices can be used, and it will be understood that only a tablet device has been shown and discussed for purposes of simplicity.

As shown in FIG. 10, the computing device 1000 can include a processor 1002 that represents a microprocessor or controller for controlling the overall operation of computing device 1000. In some embodiments, the computing device 1000 may be similar to the computing device 830 incorporated into the weighted component 240 as shown in FIGS. 8A and 8B. The computing device 1000 can also include a user input device 1008 that allows a user of the computing device 1000 to interact with the computing device 1000. For example, the user input device 1008 can take a variety of forms, such as a button, keypad, dial, touch screen, audio input interface, visual/image capture input interface, input in the form of other sensor data, and the like. Still further, the computing device 1000 can include a display 1010 (screen display) that can be controlled by the processor 1002 to display information to the user. A sensor 1060 may be optionally included and coupled to the display 1010 and/or in direct communication with the processor 1002 for receiving data obtained from the display 1010 and/or transmitting received/detected data to the processor 1002. A data bus 1016 can facilitate data transfer between at least a storage device 1040, the processor 1002, and a controller 1064. The controller 1064 can be used to interface with and control different equipment through and equipment control bus 1014. The computing device 1000 can also include a network/bus interface 1062 that couples to a data link 1012. In the case of a wireless connection, the network/bus interface 1064 can include a wireless transceiver.

The computing device 1000 can also include a storage device 1040, which can comprise a single disk or a plurality of disks (e.g., hard drives), and includes a storage management module that manages one or more partitions within the storage device 1040. In some embodiments, storage device 1040 can include flash memory, semiconductor (solid state) memory or the like. The computing device 1000 can also include a Random Access Memory (RAM) 1020 and a Read-Only Memory (ROM) 1022. The ROM 1022 can store programs, utilities or processes to be executed in a non-volatile manner. The RAM 1020 can provide volatile data storage, and stores instructions.

A stand assembly configured for use with a portable electronic device having a display screen for presenting visual content includes at least a base, a mechanical assembly supported by and movably coupled to the base, the mechanical assembly having mechanical arms and linkages, a connector at a first end of the mechanical assembly, the connector configured to detachably connect the portable electronic device to the mechanical assembly. The mechanical assembly allows movement of the connector in multiple directions to arrive at different positions and provide different adjustable orientations of the display screen with respect to the base when the portable electronic device is connected to the connector. A weighted component is coupled to the mechanical assembly at a second end that is opposite the first end, and the weighted component is configured to counterbalance a weight of the portable electronic device and maintain a set orientation of the display screen selected from the different adjustable orientations of the display screen. In one embodiment, the mechanical arms and linkages comprise a 4-bar linkage. In one embodiment, the mechanical arms and linkages comprise multiple scissor arms. In one embodiment, the connector includes a magnetic component configured to couple with a corresponding magnetic component on the portable electronic device. In one embodiment, the connector includes a pin that mates with a corresponding hole located on the portable electronic device.

In one embodiment, the mechanical assembly is configured to keep constant a presentation angle of the display screen while the mechanical assembly raises or lowers an overall position of the portable electronic device with respect to the base. In one embodiment, the mechanical assembly is configured to adjust automatically a presentation angle of the display screen while the mechanical assembly raises or lowers an overall position of the portable electronic device. In one embodiment, the rotational movement of the portable electronic device is controlled by rotating the connector with respect to the mechanical assembly. In one embodiment, a feedback component is configured to facilitate automated movement of the mechanical assembly in response to a display condition. In one embodiment, the feedback component includes a camera and the display condition includes a changed location of a user relative to the portable electronic device. In one embodiment, the portable electronic device is a tablet device.

A stand for supporting an electronic device having a display for presenting visual content includes at least a base, a device connector suitable for connecting to the electronic device, a track pole coupled to the device connector and supported by the base, the track pole including a track that allows movement of the device connector with respect to the base. When the electronic device is connected to the device connector, movement of the device connector along the track repositions the display with respect to the base. The stand also includes a spring assembly coupled to the device connector that biases the movement of the device connector along the track. In one embodiment, the spring assembly includes a spring that provides a spring force in accordance with the movement of the device connector along the track a cam coupled to the spring by way of a spring connector. In one embodiment, an amount of the spring force corresponds with the position of the device connector along the track. In one embodiment, the cam alters an amount of force used to move the device connector along the track in response to the amount of the spring force. In one embodiment, the amount of force used to move the device connector along the track is constant regardless of the position of the display with respect to the base.

A method of presenting a display screen of an electronic device is carried out by detecting a condition by a feedback component, providing a signal regarding the detected condition from the feedback component to a controller, and automatically adjusting a mechanical assembly connected to the electronic device using the controller to adjust the tilt, rotation, and lateral position of the display screen. In one embodiment, the method also includes detachably connecting the electronic device to the mechanical assembly. In one embodiment, the detachably connecting step involves a magnetic connection between a first magnetic connector at the mechanical assembly and a second magnetic connector at the electronic device. In one embodiment, the method also includes counterbalancing the weight of the electronic device using a weighted component coupled to the mechanical assembly.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A stand assembly configured for use with a portable electronic device having a display screen for presenting visual content, the stand assembly comprising:
a base;
a mechanical assembly supported by and movably coupled to the base, the mechanical assembly comprising mechanical arms and linkages;
a connector at a first end of the mechanical assembly, the connector configured to detachably connect the portable electronic device to the mechanical assembly, wherein the mechanical assembly allows movement of the connector in multiple directions to arrive at different positions and provide different adjustable orientations of the display screen with respect to the base when the portable electronic device is connected to the connector; and
a weighted component coupled to the mechanical assembly at a second end that is opposite the first end, wherein the weighted component is configured to counterbalance a weight of the portable electronic device and maintain a set orientation of the display screen selected from the different adjustable orientations of the display screen.

2. The stand assembly of claim 1, wherein the mechanical arms and linkages comprise a 4-bar linkage.

3. The stand assembly of claim 1, wherein the mechanical arms and linkages comprise multiple scissor arms.

4. The stand assembly of claim 1, wherein the connector includes a magnetic component configured to couple with a corresponding magnetic component on the portable electronic device.

5. The stand assembly of claim 1, wherein the connector includes a pin that mates with a corresponding hole located on the portable electronic device.

6. The stand assembly of claim 1, wherein the mechanical assembly is configured to keep constant a presentation angle of the display screen while the mechanical assembly raises or lowers an overall position of the portable electronic device with respect to the base.

7. The stand assembly of claim 1, wherein the mechanical assembly is configured to adjust automatically a presentation angle of the display screen while the mechanical assembly raises or lowers an overall position of the portable electronic device.

8. The stand assembly of claim 1, wherein rotational movement of the portable electronic device is controlled by rotating the connector with respect to the mechanical assembly.

9. The stand assembly of claim 1, further comprising:
a feedback component configured to facilitate automated movement of the mechanical assembly in response to a display condition.

10. The stand assembly of claim 9, wherein the feedback component comprises a camera and wherein the display condition includes a changed location of a user relative to the portable electronic device.

11. The stand assembly of claim 1, wherein the portable electronic device is a tablet device.

12. A stand for supporting an electronic device having a display for presenting visual content, the stand comprising:
a base;
a device connector suitable for connecting to the electronic device;
a track pole coupled to the device connector and supported by the base, the track pole comprising a track that allows movement of the device connector with respect to the base, wherein movement of the device connector along the track repositions the display with respect to the base when the electronic device is connected to the device connector; and
a spring assembly coupled to the device connector that biases the movement of the device connector along the track.

13. The stand of claim 12, wherein the spring assembly comprises:
a spring that provides a spring force in accordance with the movement of the device connector along the track; and
a cam coupled to the spring by way of a spring connector.

14. The stand of claim 13, wherein an amount of the spring force corresponds with a position of the device connector along the track.

15. The stand of claim 14, wherein the cam alters an amount of force used to move the device connector along the track in response to the amount of the spring force.

16. The stand of claim 15, wherein the amount of force used to move the device connector along the track is constant regardless of the position of the display with respect to the base.

17. A method of presenting a display screen of an electronic device, the method comprising:
detecting a condition by a feedback component;
providing a signal regarding the detected condition from the feedback component to a controller; and
automatically adjusting a mechanical assembly connected to the electronic device using the controller to adjust the tilt, rotation, and lateral position of the display screen in accordance with the signal.

18. The method of claim 17, further comprising:
detachably connecting the electronic device to the mechanical assembly.

19. The method of claim 18, wherein the detachably connecting step involves a magnetic connection between a first magnetic connector at the mechanical assembly and a second magnetic connector at the electronic device.

20. The method as recited in claim 17, further comprising:
counterbalancing the weight of the electronic device using a weighted component coupled to the mechanical assembly.
